(19) United States
(12) Patent Application Publication
(10) Pub. No.: US 2014/0122095 A1
(43) Pub. Date: May 1, 2014

(54) TAX SAVINGS TECHNIQUES FOR HEALTHCARE PLANS

(71) Applicant: CLAREMONT PARTNERS, INC., Alameda, CA (US)

(72) Inventor: Devon Devine, Ventura, CA (US)

(73) Assignee: CLAREMONT PARTNERS, INC., Alameda, CA (US)

(21) Appl. No.: 13/663,065

(22) Filed: Oct. 29, 2012

(51) Int. Cl. G06Q 50/22; G06Q 40/08

(52) U.S. Cl. 705/2

(57) ABSTRACT

A computer-implemented method for providing tax savings for a healthcare plan is disclosed. The computer-implemented method includes receiving an employee out of pocket (OOP) responsibility amount; subtracting from the OOP amount any amounts that are not qualified medical expenses; instructing an employer payroll computer system to split a payroll amount due the employee into a first file with an amount equal to the OOP amount and a second file with an amount equal to the normal amount due the employee less the OOP amount; send the first file to a Health Savings Account (HSA) custodian computer system; and send the second file to a Direct Deposit Account (DDA) of the employee; crediting the employee's HSA; debiting the employee's HSA; and sending the debited funds to the employee's DDA. Also disclosed are a computer system and a non-transitory computer-readable medium for performing the computer-implemented method.

### INTRODUCTION

The present disclosure generally relates to a Health Savings Account (HSA) and payment system and, more particularly, to a system and a method for providing a tax benefit to employee and employer through an HSA, without requiring the employee or the employer to fund the HSA in advance of incurring medical expenses.

Fundamental changes are occurring in the healthcare industry with respect to expenditures by consumers. Healthcare expenditures in the United States are expected to increase from approximately $558 B in 1988 to approximately $3,361 B by 2013.

Section 125 of the United States Internal Revenue Code offers tax savings to employees for medical, dependent care and childcare expenses. Likewise, Section 132 of the United States Internal Revenue Code offers employees tax savings for work-related parking and transportation expenses. For example, employees may be entitled to tax benefits if the employees withhold a portion of their payroll to pay for medical, dependent care, childcare, work-related parking expenses and/or work-related transportation expenses. In other words, the employees' payroll is taxed on the amount left after the withheld portion is subtracted from the payroll amount and the withheld portion is placed into a flexible spending account.

How consumers pay for healthcare expenditures also is changing. Presently, consumer healthcare payments is through any manner of mechanisms including cash, bank, checks, and “plastic,” which includes debit cards, charge cards, and credit cards.

An HSA is a tax-advantaged medical savings account available to taxpayers in the United States who are enrolled in a High-Deductible Health Plan (HDHP). The funds contributed to an account are not subject to federal income tax at the time of deposit. Unlike a Flexible Spending Account (FSA), funds roll over and accumulate year to year if not spent. HSAs are owned by the individual, which differentiates them from company-owned Health Reimbursement Arrangements (HRA) that are an alternate tax-deductible source of funds paired with either HDHPs or standard health plans. HSA funds may currently be used to pay for qualified medical expenses at any time without federal tax liability or penalty, with the exception of over the counter medications, which, as of early 2011, cannot be paid with HSA dollars without a doctor's prescription. Withdrawals for non-medical expenses are treated very similarly to those in an Individual Retirement Account (IRA) in that they may provide tax advantages if taken after retirement age, and they incur penalties if taken earlier. These accounts are a component of consumer-driven health care.

Proponents of HSAs believe that they are an important reform that will help reduce the growth of health care costs and increase the efficiency of the health care system. According to proponents, HSAs encourage saving for future health care expenses, allow the patient to receive needed care without a gatekeeper to determine what benefits are allowed and make consumers more responsible for their own health care choices through the required HDHP.

Opponents of HSAs say they worsen, rather than improve, the United States health system's problems because people who are healthy will leave traditional low-deductible insurance plans while people who have health problems will avoid HSAs. There is also debate about consumer satisfaction with these plans. Many consumers do not have available disposable income to save money for future healthcare expenses. Some opponents believe medical expenses should be tax-deductible for all individuals, not only those who have a savings plan.

Despite these advances, however, the present disclosure provides below a tax benefit to employee and employer through an HSA, without requiring the employee or the employer to fund the HSA in advance of incurring medical expenses, and thus maximize tax savings.

### SUMMARY

In one embodiment, a computer-implemented method for providing tax savings for a healthcare plan is disclosed. The computer-implemented method comprises receiving an employee out of pocket (OOP) responsibility amount; subtracting from the OOP amount any amounts that are not qualified medical expenses; instructing an employer payroll computer system to split a payroll amount due the employee into a first file with an amount equal to the OOP amount and a second file with an amount equal to the normal amount due the employee less the OOP amount; send the first file to a Health Savings Account (HSA) custodian computer system; and send the second file to a Direct Deposit Account (DDA) of the employee; crediting the employee's HSA; debiting the employee's HSA; and sending the debited funds to the employee's DDA.

### FIGURES

The novel features of the embodiments described herein are set forth with particularity in the appended claims. The embodiments, however, both as to organization and methods of operation may be better understood by reference to the following description, taken in conjunction with the accompanying drawings as follows.

FIG. 1 is a diagram of one embodiment of a Federal Insurance Contribution Act (FICA) tax saver network.

FIG. 2 is a logic diagram illustrating a one time basis or setup for an employee with a qualified High-Deductible Health Plan (HDHP).

FIG. 3 is a logic diagram illustrating one embodiment of a process executed by a FICA tax saver computer system on an ongoing basis for an employee with a qualified HDHP.

FIG. 4 is a transaction processing diagram illustrating one example of a conventional Health Savings Account (HAS) process without the FICA tax saver computer system.

FIG. 5 is a transaction processing diagram illustrating one embodiment of an HSA process with the FICA tax saver computer system.

FIG. 6 illustrates a computer system for implementing tax savings techniques for healthcare plans according to various embodiments.

### DESCRIPTION

Before explaining the various embodiments of the tax savings techniques for healthcare plans in detail, it should be noted that the various embodiments disclosed herein are not limited in their application or use to the details of construction and arrangement of parts illustrated in the accompanying drawings and description. Rather, the disclosed embodiments may be positioned or incorporated in other embodiments, variations and modifications thereof, and may be practiced or carried out in various ways. Accordingly, embodiments of the tax savings techniques for healthcare plans disclosed herein are illustrative in nature and are not meant to limit the scope or application thereof. Furthermore, unless otherwise indicated, the terms and expressions employed herein have been chosen for the purpose of describing the embodiments for the convenience of the reader and are not to limit the scope thereof. In addition, it should be understood that any one or more of the disclosed embodiments, expressions of embodiments, and/or examples thereof, can be combined with any one or more of the other disclosed embodiments, expressions of embodiments, and/or examples thereof, without limitation.

In the following description, like reference characters designate like or corresponding parts throughout the several views. Also, in the following description, it is to be understood that terms such as front, back, inside, outside, top, bottom and the like are words of convenience and are not to be construed as limiting terms. Terminology used herein is not meant to be limiting insofar as devices described herein, or portions thereof, may be attached or utilized in other orientations. The various embodiments will be described in more detail with reference to the drawings.

The present disclosure is directed generally to tax savings techniques for healthcare plans. A Federal Insurance Contribution Act (FICA) tax saver system according to one embodiment achieves the objective of providing a tax benefit to employee and employer through an HSA, without requiring the employee or the employer to fund the HSA in advance of incurring medical expenses.

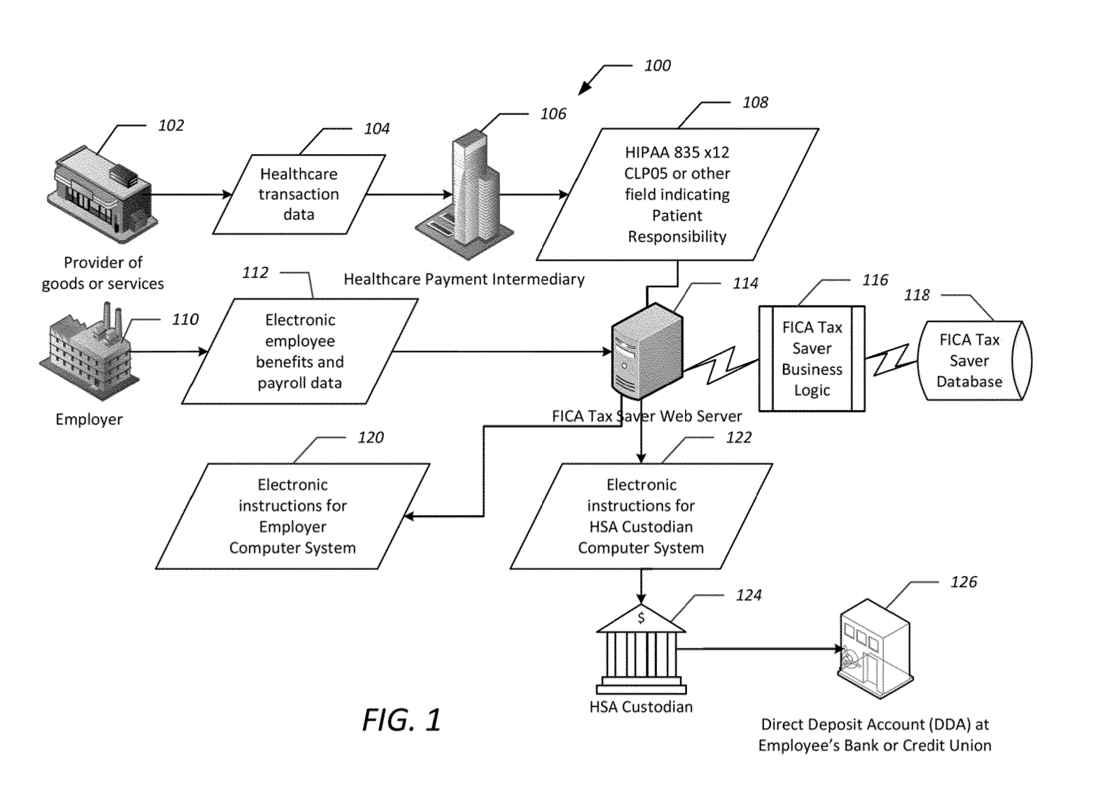

FIG. 1 is a diagram of one embodiment of a FICA tax saver network 100. A provider of goods and services 102 provides healthcare transaction data 104 to a healthcare payment intermediary 106. The healthcare transaction data 104 represents healthcare data from all sources from which a patient participating in employer's health plan may generate an HSA-qualified medical expense according to Internal Revenue Service (IRS) regulations.

The depicted healthcare transaction data 104 represents a subset of healthcare transaction data indicating the portion of financial responsibility accruing to the patient. One standard file type is ASC X12 Health Care Claim Payment/Advice (835) transaction version 4010A1 mandated by the Health Insurance Portability and Accountability Act (HIPAA) for the transfer of Electronic Remittance Advice (ERA) information to health care providers. In this instance, a Patient Responsibility Amount field 108 (CLP05) of the Claim Payment Information segment (CLP) will have a positive value. At least one of the service lines will have a CAS*PR adjustment with an appropriate adjustment reason code (i.e., 3—Co-Payment, 2—Coinsurance, 1—Deductible Amount, etc.) that reduces the payment amount of the applicable service line.

For example, the following claim has a co-payment amount of $15.00. It is reflected in the CLP05 field 108 and in the CAS*PR adjustment for $15.00 below in TABLE 1.

TABLE 1

CLP*2020202020*1*100*85*15*HM*123123123*13*1~
NM1*QC*1*DOE*JANE****MI*99988777701~
NM1*82*2*YORK HOSPITAL*****FI*231352222~
REF*1L*18~
REF*G2*43995~
DTM*050*20040312~
SVC*HC>80051*100*85**1~
CAS*PR*3*15~
DTM*150*20040305~
DTM*151*20040305~
REF*LU*22~
REF*6R*123123-1~
REF*1C*43995~

The employer 110 electronically transfers or transmits Employee Benefits and Payroll Data 112, as described in TABLE 1, to a FICA saver web server 114. No less frequently than once per year, the FICA saver web server 114 authenticates the identity of the entities (Healthcare Payment Intermediary, Employer, HSA Custodian) and electronically transmits the data described in TABLE 2 to a computer that applies FICA saver business logic 116.

TABLE 2

| Entity | | | |
|---|---|---|---|
| Name | Entity Description | Data Received | Data Sent |
| Healthcare | Entity responsible for | HIPAA 835 x12 | Confirmation of |
| Payment | adjudication, repricing, | CLP05 or other field | receipt of data |
| Intermediary | application of benefit | indicating Patient | received. |
| | design, or payment of | Responsibility | |
| | healthcare claims. | | |
| | Sometimes will be | | |
| | described as the | | |
| | “Administrative Services | | |
| | Only” provider or “Third | | |
| | Party Administrator”. | | |
| Employer | Employer or self-insured | 1) unique identifiers | HSA contribution |
| | healthcare trust | for employer's | file directing |
| | | employees and other | amounts equal to |
| | | subscribers to an | qualified medical |
| | | HSA-qualified health | expenses up to |
| | | plan | allowable |
| | | 2) employee | contribution |
| | | authorizations to debit | maximum |
| | | and credit various | |
| | | employee-owned | |
| | | financial accounts | |
| | | 3) routing and transit | |
| | | information for | |
| | | employees' health | |
| | | savings accounts and | |
| | | payroll deposit | |
| | | accounts | |
| HSA | Any custodian of HSA | Confirmation of | Instructions |
| Custodian | funds as permitted by IRS | receipt of instructions | effective upon |
| | regulations, typically a bank | sent. | receipt of |
| | or credit union | | identified payroll |
| | | | file from Employer, |
| | | | to |
| | | | 1) credit the HSAs |
| | | | indicated in the |
| | | | file, |
| | | | 2) then |
| | | | immediately |
| | | | initiate an equal |
| | | | and corresponding |
| | | | debit, and |
| | | | 3) send the |
| | | | debited funds to |
| | | | the indicated DDA |
| | | | at bank or credit |
| | | | union used by |
| | | | employee for |
| | | | direct payroll |
| | | | deposit |

The FICA saver business logic 116 includes computer executable instructions (software), that when executed by a computer confirms that the transaction description matches known descriptors of qualified medical expenses. The system deems matching transactions to be qualified medical expenses. The computer also confirms that accumulated patient financial responsibility per patient does not exceed statutory allowable HSA contribution maximum for the linked HSA account.

The FICA saver database 118 database maintains records on unique identifiers for employer's employees and other subscribers to an HSA-qualified health plan and employee authorizations to debit and credit various employee-owned financial accounts. The FICA saver database 118 also maintains routing and transit information for employees' health savings accounts and payroll deposit accounts, descriptors for qualified medical expenses, and records of employee contributions to an HSA.

The FICA web server 114 also transmits electronic instructions for the employer computer system 120 and transmits electronic instructions for the HSA custodian computer system 122. The data transmission with the employer and with the HSA custodian is described TABLE 2 above.

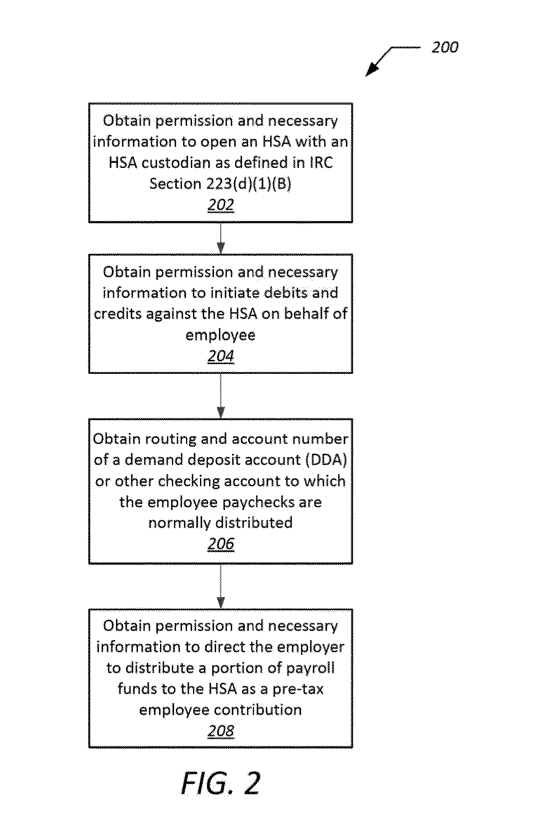

Having described one embodiment of a FICA tax saver network 100 in which various embodiments of the tax savings techniques for healthcare plans can be practiced, the description now turns to FIG. 2, which is a logic diagram 200 illustrating a one time basis or setup for an employee with a qualified HDHP. At 202, the system obtains permission and necessary information to open an HSA with an HSA custodian as defined in IRC Section 223(d)(1)(B) and, at 204, the system obtains permission and necessary information to initiate debits and credits against the HSA on behalf of employee. At 206, the system obtains routing and account number of a demand deposit account (DDA) or other checking account to which the employee paychecks are normally distributed. At 208, the system obtains permission and necessary information to direct the employer to distribute a portion of payroll funds to the HSA as a pre-tax employee contribution.

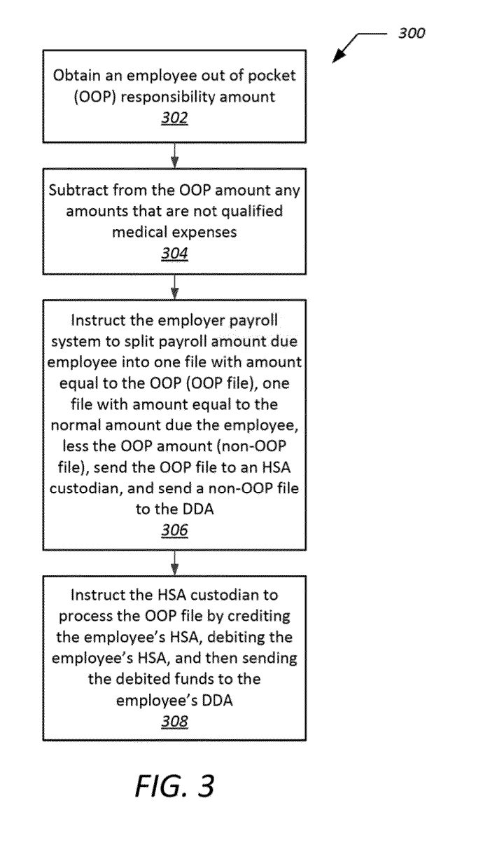

FIG. 3 is a logic diagram 300 illustrating one embodiment of a process executed by a FICA tax saver computer system on an ongoing basis for an employee with a qualified HDHP. At 302, the FICA tax saver computer system obtains an employee out of pocket (OOP) responsibility amount by extracting data from the appropriate field in the HIPAA-standard healthcare transaction data available through employer-sponsored health plan, such as the HIPAA 835×12 CLP05 or other field indicating patient (employee) responsibility amount, as indicated in TABLE 1, for example. At 304, the FICA tax saver computer system subtracts from the OOP amount any amounts that are not qualified medical expenses. At 306, the FICA tax saver computer system instructs the employer payroll system to split payroll amount due employee into one file with amount equal to the OOP (OOP file), one file with amount equal to the normal amount due the employee, less the OOP amount (non-OOP file), send the OOP file to an HSA custodian, and send a non-OOP file to the DDA. At 308, the FICA tax saver computer system instructs the HSA custodian to process the OOP file by crediting the employee's HSA, debiting the employee's HSA, and then sends the debited funds to the employee's DDA. The term “file” depicted at 306 and 308 contains authorization, direction, and detail necessary to effect a transfer of funds between financial institution accounts or subaccounts, such as by Automated Clearinghouse (ACH), wire, or other method.

The FICA tax saver computer system also provides exception handling as follows. When the OOP amount for a given payroll cycle exceeds the payroll amount, the system will carry over the excess amount to the subsequent payroll cycle. When the OOP amount for a given payroll cycle would cause the total HSA contributions for the year to exceed the statutory maximum, the system will carry over the OOP amount to the subsequent tax year.

The HSA custodian provides standard tax reporting to employee (5498-SA), employer, and the IRS. The HSA custodian is responsible for ensuring that no debits or credits are made to the HSA in the absence of an instruction from the system.

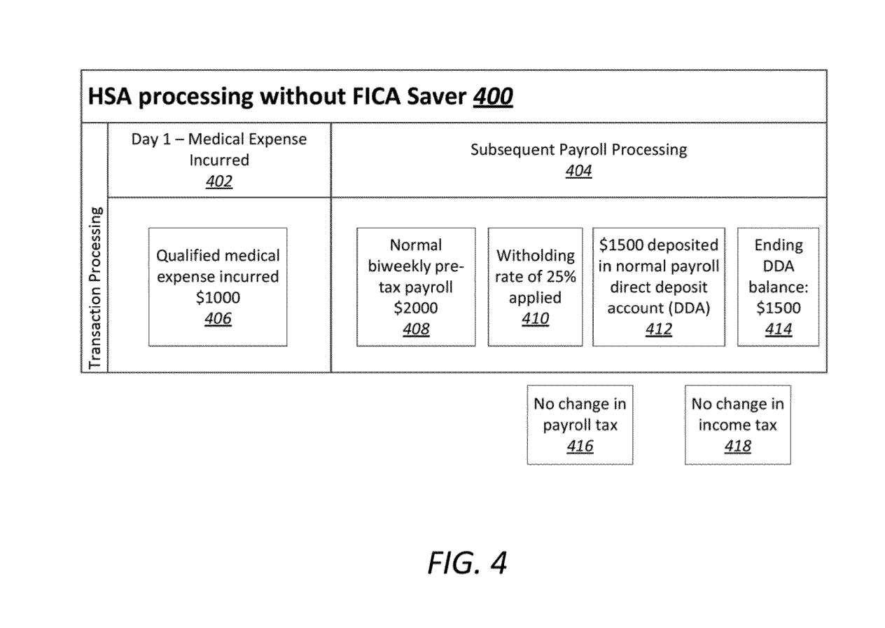

The description now turns to FIG. 4, which is a transaction processing diagram illustrating one example of a conventional HSA process 400 without the FICA tax saver computer system. The conventional HSA process 400 does not provide any change in payroll taxes or income taxes based on a medical expense. The conventional HSA process 400 is initiated on day 1, at 402, with a medical expense incurred and, at 404, subsequent payroll processing. At 406, for example, a qualified medical expense of $1000 is incurred. At 408, normal biweekly pre-tax payroll of $2000 is processed. At 410, a withholding rate of 25% is applied to the biweekly pretax payroll amount of $2000. Thus $500 is withheld. At 412, the $1500 balance is deposited in a normal payroll direct deposit account (DDA). At 414, the ending DDA balance is $1500. Accordingly, as shown at 416, there is no change in payroll tax and as shown at 418, there is no change in income tax.

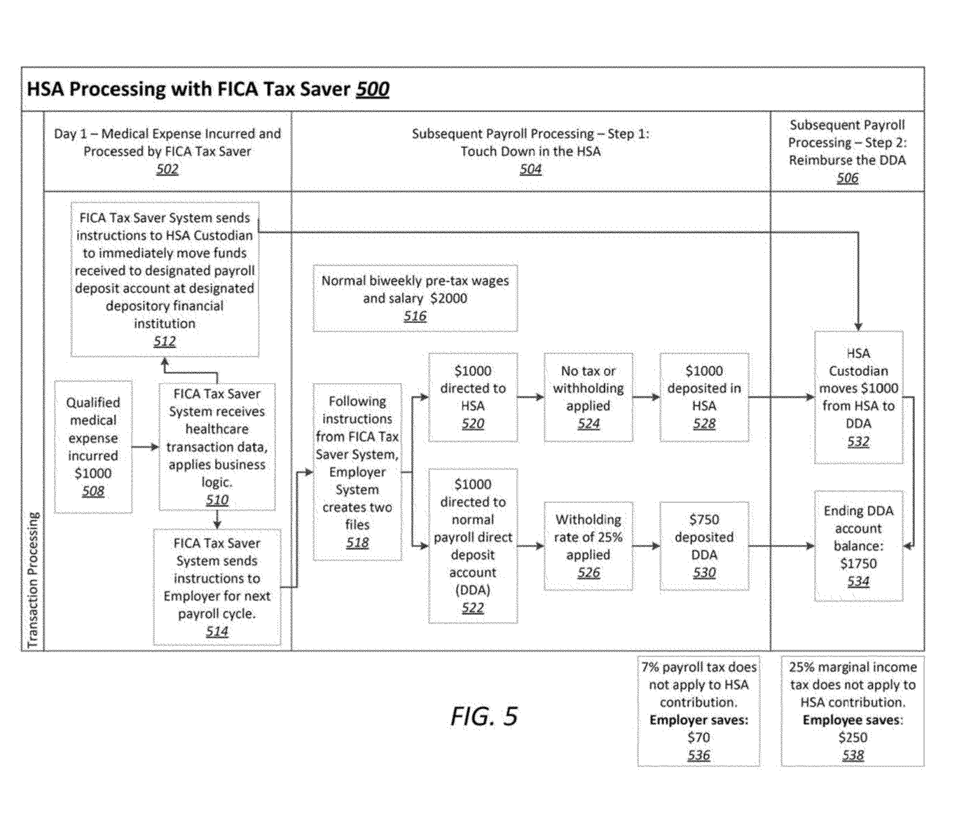

FIG. 5 is a transaction processing diagram illustrating one embodiment of an HSA process 500 with the FICA tax saver computer system. The HSA process 500 is described in conjunction with the FICA tax saver network 100 of FIG. 1 and network 100 and the logic diagram 300 of FIG. 3. With reference to FIG. 5, the same payroll and withholding rates used in the conventional HSA process 400 without the FICA tax saver of FIG. 4 is used the HSA process 500 with the FICA tax saver of FIG. 5 to enable a comparison of the tax savings achieved. Accordingly as shown in FIG. 5, on day 1, at 502, a medical expense is incurred and processed by the FICA tax saver computer system. The subsequent payroll process includes a first step 504, touch down in the HSA, and a second step 506, reimburse the DDA. At 508, a qualified medical expense of $1000 is incurred and at 510, the FICA tax saver computer system receives healthcare transaction data and applies business logic to the transaction data. At 512, the FICA tax saver computer system sends instructions to the HSA custodian to, upon receipt of employee pre-tax contribution, immediately move funds received to designated payroll deposit account at designated depository financial institution. At 514, the FICA tax saver computer system sends instructions to the employer for the next payroll cycle.

During the first step 504 of the subsequent payroll processing cycle, at 516, the normal biweekly pre-tax wages and salary is $2000. As previously discussed, at 512, the FICA tax saver computer system sends instructions to the HSA custodian to immediately move funds received to designated payroll deposit account at designated depository financial institution. At 518, following instructions from the FICA tax saver computer system, the employer system creates two files. In a first process, at 520, $1000 is directed to the HSA and at 524, no tax or withholding is applied to the $1000. At 528, the $1000 is deposited in the HSA and at 532, the HSA custodian moves the $1000 from the HSA to the DDA in accordance with the instructions received from the FICA tax saver computer system at 512. In a second process, at 526, $1000 is directed to the normal DDA. At 526, a withholding rate of 25% is applied by the payroll process to the $1000 in wages and salary otherwise directed to the DDA. Thus $250 is withheld. At 530, the balance of $750 is deposited in a DDA. At 534, the $750 from the DDA is combined with the $1000 from the DDA for a balance of $1750.

As indicated at 536, the 7% payroll tax does not apply to HSA contributions, this saving the employer $70. In addition, as indicated at 538, the 25% marginal income tax does not apply to HSA contribution and thus the employee saves $250.

The foregoing example illustrated in FIG. 5 used a single $1000 out of pocket medical expense, which generated $250 in tax savings for the employee and $70 in tax savings for the employer through the FICA tax saver computer system. According, to published research, the average family with a HDHP has $3000 in out of pocket medical expenses per year. Therefore, the FICA tax saver computer system can be expected to annually save the average employee $750 and the average employer $210 per employee for a total tax savings of $960, as shown in TABLE 3.

TABLE 3

| | With FICA Tax Saver | Without FICA Tax Saver |
|---|---|---|
| Employee Value | $750 | $0 |
| Employer Value | $210 | $0 |
| Total Value | $960 | $0 |

As used herein, the term “computer” generally refers to hardware or hardware in combination with one or more program(s), such as can be implemented in software. Computer aspects can be implemented on general purpose computers or specialized devices, and can operate electrically, optically, or in any other fashion. A computer as used herein can be viewed as at least one computer having all functionality or as multiple computers with functionality separated to collectively cooperate to bring about the functionality. Logic flow can represent signal processing, such as digital data processing, communication, or as evident from the context hereinafter. Logic flow can be implemented in discrete circuits. Computer-readable media, as used herein can comprise at least one of a RAM, a ROM, A disk, an ASIC, and a PROM. Industrial applicability is clear from the description, and is also stated below.

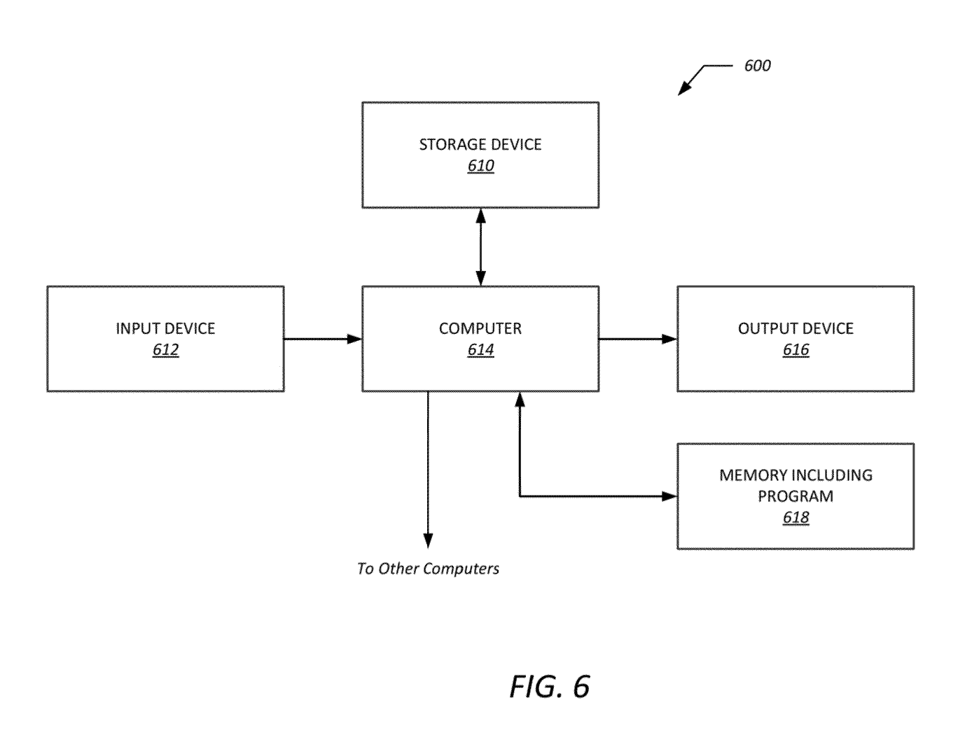

FIG. 6 illustrates a computer system 600 for implementing tax savings techniques for healthcare plans according to various embodiments. By way of the following prophetic teaching, there is provided computer support, as in a data processing system, for implementing a FICA tax saver computer system. The computer support for the computer-implemented method of the tax savings techniques for healthcare plans may be implemented by a computer system 600 as shown FIG. 6, or it may be implemented by multiple computers that may be connected or networked together in an ongoing manner, intermittently, or one time. In any case, control of such system can be enabled in accordance herein discussed below. The computer system 600 may include a computer 614, an input device 612 such as a keyboard, a storage device 610 such as a memory, a memory 618 including a program, such as a disk (note the storage 610 and memory 618 may or may not be the same device, depending on the implementation desired, in one embodiment the storage device 610 is a non-transitory storage device) including software, and an output device 616 such as a monitor screen, computer-to-computer communication device (e.g., modem), and/or a printer.

In one embodiment herein, a computer-readable media or memory 618 is provided, the computer-readable media or memory 618 tangibly embodying a program of instructions executable by the computer system to perform the steps of: receiving an employee out of pocket (OOP) responsibility amount by the FICA tax saver computer system; subtracting from the OOP amount by the FICA tax saver computer system any amounts that are not qualified medical expenses; instructing by the FICA tax saver computer system the employer payroll system to split payroll amount due an employee into one file with an amount equal to the OOP (OOP file), one file with an amount equal to the normal amount due the employee, less the OOP amount (non-OOP file); sending the OOP file by the FICA tax saver computer system to an HSA custodian; and sending by the FICA tax saver computer system a non-OOP file to the DDA; instructing by the FICA tax saver computer system the HSA custodian to process the OOP file by crediting the employee's HAS; debiting by the HSA custodian computer system the employee's HSA; and sending by the HSA custodian computer system the debited funds to the employee's DDA. The FICA tax saver computer system also provides exception handling as follows. When the OOP amount for a given payroll cycle exceeds the payroll amount, the FICA tax saver computer system will carry over the excess amount to the subsequent payroll cycle. When the OOP amount for a given payroll cycle would cause the total HSA contributions for the year to exceed the statutory maximum, the FICA tax saver computer system will carry over the OOP amount to the subsequent tax year. The HSA custodian computer system also provides standard tax reporting to employee (5498-SA), employer, and the IRS. The HSA custodian computer system is responsible for ensuring that no debits or credits are made to the HSA in the absence of an instruction from the system. Indeed the program instructions can be such as to carry out any computer-assisted method or operation discussed herein.

In one embodiment, the computer support may include a process for controlling a computer system that implements the FICA tax saver computer system. The system for controlling a computer system may include a switching system, which at a simplest level, can be menu displayed on a computer screen. The system for controlling may be structured to offer choices to solicit predetermined data or trigger predetermined operations, including, for example: entering data associated with the FICA tax saver computer system.

In one embodiment, a plurality of computers can cooperate to implement the tax savings techniques for healthcare plans. For example, each computer system can utilize a computer-to-computer communication device, and such as a network (e.g., telephone, Internet, cable, etc.) with electronic transmission means for (e.g., email, real time communication system, or the like), e.g., with a corresponding receiver system, in communicating between the computers to enable the computers to cooperate in carrying out the implementing of computer-implemented tax savings techniques for healthcare plans.

For example, the plurality of computers may implement a computer-implemented system configured to execute a program of instructions executable by the computer system to receive an employee out of pocket (OOP) responsibility amount by the FICA tax saver computer system; subtract from the OOP amount by the FICA tax saver computer system any amounts that are not qualified medical expenses; instruct by the FICA tax saver computer system the employer payroll system to split payroll amount due an employee into one file with an amount equal to the OOP (OOP file), one file with an amount equal to the normal amount due the employee, less the OOP amount (non-OOP file); send the OOP file by the FICA tax saver computer system to an HSA custodian; and send by the FICA tax saver computer system a non-OOP file to the DDA; instruct by the FICA tax saver computer system the HSA custodian to process the OOP file by crediting the employee's HAS; debit by the HSA custodian computer system the employee's HSA; and send by the HSA custodian computer system the debited funds to the employee's DDA. The FICA tax saver computer system also provides exception handling as follows. When the OOP amount for a given payroll cycle exceeds the payroll amount, the FICA tax saver computer system will carry over the excess amount to the subsequent payroll cycle. When the OOP amount for a given payroll cycle would cause the total HSA contributions for the year to exceed the statutory maximum, the FICA tax saver computer system will carry over the OOP amount to the subsequent tax year. The HSA custodian computer system also provides standard tax reporting to employee (5498-SA), employer, and the IRS. The HSA custodian computer system is responsible for ensuring that no debits or credits are made to the HSA in the absence of an instruction from the system.

If implemented by more than one computer, the computer system 600 may include at least a provider of goods or services computer system, a healthcare payment intermediary computer system, a FICA tax saver web server computer system, an employer computer system, an HSA custodian computer system, a DDA computer system (or employee's bank or credit union computer system), a FICA tax saver business logic computer system, and a FICA tax saver database, among other computer systems and components. Any or all of the computer systems may include one or all of the following: an input device 612, such as a keyboard; a storage device 610; an output device 616; a memory 618, including a program, the foregoing articulated in greater exemplification with regard to FIG. 6, e.g., with the storage device 610 and memory 618 being separate or the same, as one may prefer in one implementation or another.

While various details have been set forth in the foregoing description, it will be appreciated that the various aspects of the tax savings techniques for healthcare plans may be practiced without these specific details. For example, for conciseness and clarity selected aspects have been shown in block diagram form rather than in detail. Some portions of the detailed descriptions provided herein may be presented in terms of instructions that operate on data that is stored in a computer memory. Such descriptions and representations are used by those skilled in the art to describe and convey the substance of their work to others skilled in the art. In general, an algorithm refers to a self-consistent sequence of steps leading to a desired result, where a “step” refers to a manipulation of physical quantities which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities.

Unless specifically stated otherwise as apparent from the foregoing discussion, it is appreciated that, throughout the foregoing description, discussions using terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It is worthy to note that any reference to “one aspect,” “an aspect,” “one embodiment,” or “an embodiment” means that a particular feature, structure, or characteristic described in connection with the aspect is included in at least one aspect. Thus, appearances of the phrases “in one aspect,” “in an aspect,” “in one embodiment,” or “in an embodiment” in various places throughout the specification are not necessarily all referring to the same aspect. Furthermore, the particular features, structures or characteristics may be combined in any suitable manner in one or more aspects.

Some aspects may be described using the expression “coupled” and “connected” along with their derivatives. It should be understood that these terms are not intended as synonyms for each other. For example, some aspects may be described using the term “connected” to indicate that two or more elements are in direct physical or electrical contact with each other. In another example, some aspects may be described using the term “coupled” to indicate that two or more elements are in direct physical or electrical contact. The term “coupled,” however, also may mean that two or more elements are not in direct contact with each other, but yet still co-operate or interact with each other.

It is worthy to note that any reference to “one aspect,” “an aspect,” “one embodiment,” or “an embodiment” means that a particular feature, structure, or characteristic described in connection with the aspect is included in at least one aspect. Thus, appearances of the phrases “in one aspect,” “in an aspect,” “in one embodiment,” or “in an embodiment” in various places throughout the specification are not necessarily all referring to the same aspect. Furthermore, the particular features, structures or characteristics may be combined in any suitable manner in one or more aspects.

Although various embodiments have been described herein, many modifications, variations, substitutions, changes, and equivalents to those embodiments may be implemented and will occur to those skilled in the art. Also, where materials are disclosed for certain components, other materials may be used. It is therefore to be understood that the foregoing description and the appended claims are intended to cover all such modifications and variations as falling within the scope of the disclosed embodiments. The following claims are intended to cover all such modification and variations.

Some or all of the embodiments described herein may generally comprise technologies for implementing computer-implemented tax savings techniques for healthcare plans, or otherwise according to technologies described herein. In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

All of the above-mentioned U.S. patents, U.S. patent application publications, U.S. patent applications, foreign patents, foreign patent applications, non-patent publications referred to in this specification and/or listed in any Application Data Sheet, or any other disclosure material are incorporated herein by reference, to the extent not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory.

Although various embodiments have been described herein, many modifications, variations, substitutions, changes, and equivalents to those embodiments may be implemented and will occur to those skilled in the art. Also, where materials are disclosed for certain components, other materials may be used. It is therefore to be understood that the foregoing description and the appended claims are intended to cover all such modifications and variations as falling within the scope of the disclosed embodiments. The following claims are intended to cover all such modification and variations.

In summary, numerous benefits have been described which result from employing the concepts described herein. The foregoing description of the one or more embodiments has been presented for purposes of illustration and description. It is not intended to be exhaustive or limiting to the precise form disclosed. Modifications or variations are possible in light of the above teachings. The one or more embodiments were chosen and described in order to illustrate principles and practical application to thereby enable one of ordinary skill in the art to utilize the various embodiments and with various modifications as are suited to the particular use contemplated. It is intended that the claims submitted herewith define the overall scope.

1. A computer-implemented method for providing tax savings for a healthcare plan, the computer-implemented method comprising:
receiving, by a computer system, an employee out of pocket (OOP) responsibility amount;
subtracting, by the computer system, from the OOP amount any amounts that are not qualified medical expenses;
instructing, by the computer system, an employer payroll computer system to:
split a payroll amount due the employee into a first file with an amount equal to the OOP amount and a second file with an amount equal to the normal amount due the employee less the OOP amount;
send the first file to a Health Savings Account (HAS) custodian computer system; and
send the second file to a Direct Deposit Account (DDA) of the employee;
crediting, by the computer system, the employee's HSA;
debiting, by the computer system, the employee's HSA; and
sending, by the computer system, the debited funds to the employee's DDA.

2. The computer-implemented method of claim 1, comprising extracting, by the computer system, data from a field in a Health Insurance Portability and Accountability Act (HIPAA)-standard healthcare transaction data available through employer-sponsored health plan, the data indicating the employee responsibility amount.

3. The computer-implemented method of claim 2, wherein the HIPAA field is defined as 835×12 CLP05.

4. The computer-implemented method of claim 1, comprising instructing, by the computer system, the employer payroll computer system to split the payroll amount due the employee into the first and second file.

5. The computer-implemented method of claim 1, comprising:
determining, by the computer system, when the OOP amount for a given payroll cycle exceeds the payroll amount; and
carrying over, by the computer system, the excess amount to a subsequent payroll cycle.

6. The computer-implemented method of claim 1, comprising:
determining, by the computer system, when the OOP amount for a given payroll cycle causes the total HSA contributions for the year to exceed the statutory maximum; and
carrying over, by the computer system, the OOP amount to a subsequent tax year.

7. A computer system for providing tax savings for a healthcare plan, the computer system comprising:
a computer;
a non-transitory storage device coupled to the computer;
a memory including a program of executable instructions that, when executed by the computer, cause the computer to:
receive an employee out of pocket (OOP) responsibility amount;
subtract from the OOP amount any amounts that are not qualified medical expenses;
instruct an employer payroll computer system to:
split a payroll amount due the employee into a first file with an amount equal to the OOP amount and a second file with an amount equal to the normal amount due the employee less the OOP amount;
send the first file to a Health Savings Account (HAS) custodian computer system; and
send the second file to a Direct Deposit Account (DDA) of the employee;
credit the employee' HSA;
debit the employee's HSA; and
send the debited funds to the employee's DDA.

8. The computer system of claim 7, wherein when executed by the computer, the computer executable instructions cause the computer to extract data from a field in a Health Insurance Portability and Accountability Act (HIPAA)-standard healthcare transaction data available through employer-sponsored health plan, the data indicating the employee responsibility amount.

9. The computer system of claim 8, wherein the HIPAA field is defined as 835×12 CLP05.

10. The computer system of claim 7, wherein when executed by the computer, the computer executable instructions cause the computer to instruct the employer payroll computer system to split the payroll amount due the employee into the first and second file.

11. The computer system of claim 7, wherein when executed by the computer, the computer executable instructions cause the computer to:
determine when the OOP amount for a given payroll cycle exceeds the payroll amount; and
carry over the excess amount to a subsequent payroll cycle.

12. The computer system of claim 7, wherein when executed by the computer, the computer executable instructions cause the computer to:
determine when the OOP amount for a given payroll cycle causes the total HSA contributions for the year to exceed the statutory maximum; and
carry over the OOP amount to a subsequent tax year.

13. A non-transitory computer-readable medium having computer-executable instructions for execution by a computer processing system, the computer-executable instructions for processing tax savings for a healthcare plan, the computer-readable medium comprising instructions that:
receive an employee out of pocket (OOP) responsibility amount;
subtract from the OOP amount any amounts that are not qualified medical expenses;
instruct an employer payroll computer system to:
split a payroll amount due the employee into a first file with an amount equal to the OOP amount and a second file with an amount equal to the normal amount due the employee less the OOP amount;
send the first file to a Health Savings Account (HAS) custodian computer system; and
send the second file to a Direct Deposit Account (DDA) of the employee;
credit the employee's HSA;
debit the employee's HSA; and
send the debited funds to the employee's DDA.

14. The non-transitory computer-readable medium of claim 12, comprising instructions that extract data from a field in a Health Insurance Portability and Accountability Act (HIPAA)-standard healthcare transaction data available through employer-sponsored health plan, the data indicating the employee responsibility amount.

15. The non-transitory computer-readable medium of claim 13, comprising instructions that define the HIPAA field as 835×12 CLP05.

16. The non-transitory computer-readable medium of claim 12, comprising instructions that split the payroll amount due the employee into the first and second file.

17. The non-transitory computer-readable medium of claim 12, comprising instructions that:
determine when the OOP amount for a given payroll cycle exceeds the payroll amount; and
carry the excess amount to a subsequent payroll cycle.

18. The non-transitory computer-readable medium of claim 12, comprising instructions that:
determine when the OOP amount for a given payroll cycle causes the total HSA contributions for the year to exceed the statutory maximum; and
carry over the OOP amount to a subsequent tax year.
